(19) United States
(12) Patent Application Publication
(10) Pub. No.: US 2025/0301334 A1
(43) Pub. Date: Sep. 25, 2025

(54) BEAM SCANNING METHOD AND APPARATUS, AND COMPUTER-READABLE STORAGE MEDIUM

(71) Applicant: SPREADTRUM SEMICONDUCTOR (NANJING) CO., LTD., Nanjing, Jiangsu (CN)

(72) Inventors: Runquan MIAO, Pudong New Area, Shanghai (CN); Qiyishu LI, Pudong New Area, Shanghai (CN)

(21) Appl. No.: 18/716,328

(22) PCT Filed: Dec. 13, 2022
(86) PCT No.: PCT/CN2022/138580

§ 371 Date: Jun. 4, 2024

(30) Foreign Application Priority Data
Dec. 14, 2021 (CN) 202111527283.1

(51) Int. Cl. H04W 16/28; H04W 8/22; H04W 64/00

(52) U.S. Cl. CPC H04W 16/28; H04W 8/22; H04W 64/00

(57) ABSTRACT

A beam scanning method and apparatus, and a computer-readable storage medium are provided. The beam scanning method includes: acquiring obstacle information within a coverage area and position information of a target UE; and determining an optimal beam corresponding to the target UE based on the obstacle information and the position information of the target UE.

### CROSS-REFERENCE TO RELATED APPLICATIONS

This is the U.S. national stage of application No. PCT/CN2022/138580, filed on Dec. 13, 2022. Priority under 35 U.S.C. § 119(a) and 35 U.S.C. § 365(b) is claimed from Chinese Application No. 202111527283.1, filed Dec. 14, 2021, the disclosure of which is also incorporated herein by reference.

### TECHNICAL FIELD

The present disclosure generally relates to radio communication technology field, and more particularly, to a beam scanning method and apparatus, and a computer-readable storage medium.

### BACKGROUND

With the evolution of radio communication technology, operating frequency bands are developing towards higher frequency bands such as millimeter wave, terahertz and visible light. For millimeter wave and higher frequency band communication, beams with smaller beam angles are used to make up for a relatively small coverage of high-frequency communication, thus, more beams are needed for beam scanning.

In existing techniques, it is usually necessary to determine an optimal beam corresponding to a User Equipment (UE) through a beam scanning process. In a current beam scanning process, assuming that a base station transmits M beams and a UE has N beams, it is necessary to establish M×N beam pairs.

### SUMMARY

Embodiments of the present disclosure may reduce complexity of a beam scanning process.

In an embodiment of the present disclosure, a beam scanning method is provided, including: acquiring obstacle information within a coverage area and position information of a target UE; and determining an optimal beam corresponding to the target UE based on the obstacle information and the position information of the target UE.

In an embodiment of the present disclosure, a non-volatile or non-transitory computer-readable storage medium having computer instructions stored therein is provided, wherein when the computer instructions are executed by a processor, any one of the above beam scanning methods is performed.

In an embodiment of the present disclosure, a beam scanning apparatus including a memory and a processor is provided, wherein the memory has computer instructions stored therein, and when the processor executes the computer instructions, any one of the above beam scanning methods is performed.

### BRIEF DESCRIPTION OF THE DRAWINGS

FIG. 1 is a flow chart of a beam scanning method according to an embodiment;

FIG. 2 is a block diagram of a beam scanning apparatus according to an embodiment; and

FIG. 3 is an application scenario diagram of a beam scanning method according to an embodiment.

### DETAILED DESCRIPTION

As described in the background, in a current beam scanning process, a base station transmits M beams to cover a range of 360°. As a beam angle of beams becomes smaller, a number of beams that the base station needs to transmit increases, which significantly increases complexity of the beam scanning process.

In embodiments of the present disclosure, as the optimal beam is determined based on the obstacle information within the coverage area and the position information of the target UE, the optimal beam can be determined without performing full-angle beam scanning, thereby effectively reducing complexity of a beam scanning process.

In order to clarify the objects, characteristics and advantages of the disclosure, embodiments of present disclosure will be described in detail in conjunction with accompanying drawings.

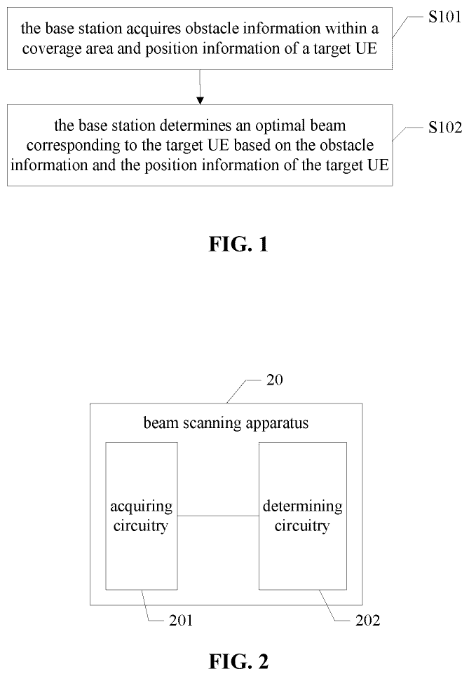

An embodiment of the present disclosure provides a beam scanning method. Referring to FIG. 1, detailed description is given below through specific steps.

In some embodiments, the beam scanning method including S101 and S102 may be performed by a base station. Specifically, S101 and S102 may be performed by a chip with a data processing function in a base station, or by a chip module containing a chip with a data processing function in a base station.

In S101, the base station acquires obstacle information within a coverage area and position information of a target UE.

In some embodiments, the base station can acquire the obstacle information within the coverage area. The coverage area of the base station may be a range that signals of the base station can cover. The obstacle information may include obstacle distribution information that indicates in which directions obstacles exist within the coverage area of the base station.

In some embodiments, the obstacle information further includes a reflection area corresponding to each obstacle, a reflection coefficient corresponding to each obstacle, etc. By acquiring the reflection area corresponding to the obstacle and the reflection coefficient corresponding to the obstacle, an area size corresponding to the obstacle and a surface material of the obstacle may be calculated, and further a type of the obstacle is determined. The type of obstacles includes pedestrian, vehicle, building, etc.

For example, the obstacle is determined to be a building based on the reflection area and the reflection coefficient corresponding to the obstacle. Combined with distribution information of the obstacle, distribution of the obstacle in each direction within the coverage area of the base station and the type of the obstacle are determined.

In some embodiments, the base station may transmit a detection signal within the coverage area, and determine first obstacle information within the coverage area based on an echo of the detection signal. When the base station is in an open space, for example, the base station is set on a roadside, there may be few obstacles within its coverage area, and the first obstacle information acquired by the base station can be directly used as the obstacle information within the coverage area.

In some embodiments, there may be many obstacles or a building within the coverage area of the base station. When there is a building within the coverage area of the base station, the signal transmitted by the base station may not be able to cover the back of the building, resulting in the base station being unable to configure an optimal beam for a UE located at the back of the building, and thus the UE located at the back of the building has low signal quality.

In some embodiments, after acquiring the first obstacle information within the coverage area, the base station can also acquire a detection range of the target UE and second obstacle information detected by the target UE within the detection range. The base station may combine the first obstacle information with the second obstacle information to acquire the required obstacle information.

After accessing the base station, the target UE may report capability information to the base station. The UE capability information may include whether the target UE has detection capability, and further include a detection range of the target UE if the target UE has the detection capability. After accessing the base station, the target UE may further report its corresponding geographic position information to the base station. There is no logical order between the step of the target UE reporting the capability information to the base station and the step of the target UE reporting the geographic position information to the base station. Specifically, the target UE may first report the capability information to the base station, and then report the geographic position information to the base station; or, the target UE may first report the geographic position information to the base station, and then report the capability information to the base station; or, the target UE may report the geographic position information and the capability information to the base station simultaneously, and the geographic position information and the capability information may be carried by a same signaling or different signalings.

After receiving the UE capability information corresponding to the target UE, the base station may determine whether to trigger the target UE to perform a detection operation based on the acquired first obstacle information, the position information of the target UE, and the capability information of the target UE.

If the target UE has the detection capability, and the base station determines to trigger the target UE to perform a detection operation, the base station may transmit indication information to the target UE. After receiving the indication information, the target UE may perform a detection operation to acquire the second obstacle information within the detection range. The target UE may report the second obstacle information to the base station.

In some embodiments, the second obstacle information may include a number of obstacles within the detection range, distribution information of the obstacles, a reflection area of the obstacles, a reflection coefficient of the obstacles, and the like.

In some embodiments, one or more perception units may be provided in the base station. Through the sensing unit, the base station can perceive obstacle information within the coverage area.

In some embodiments, the perception unit may be a radar unit which transmits a detection signal to acquire obstacle information within the coverage area. The perception unit may be an antenna module of the base station. During a perception process, the base station may control the antenna module to transmit omnidirectional beams which serve as the detection signal. The base station may receive a reflected signal corresponding to the omnidirectional beams to determine the obstacle information within the coverage area.

Using the antenna module of the base station as the perception unit does not require additional hardware equipment, thereby no extra cost being caused. In the existing techniques, after controlling the antenna module to transmit the omnidirectional beams, the base station essentially only receives measurement results corresponding to one or more beams fed back by the UE, while other beams are essentially not fully utilized.

For example, the base station controls the antenna module to transmit 12 beams covering a range of 360°. However, the UE may only measure beams in two directions and feedback, and remaining ten beams are not fully utilized.

In the above embodiments, after controlling the antenna module to transmit the omnidirectional beams, the base station receives the reflected signals corresponding to all the beams, to further determine the obstacle information within the coverage area, thereby improving utilization efficiency of the beams.

For example, the base station controls the antenna module to transmit 12 beams covering a range of 360°. However, the UE may only measure beams in two directions and feed back. However, the base station can receive the reflected signals corresponding to the 12 beams, thus, the 12 beams are fully utilized.

It could be understood that the perception unit may be other types of unit, as long as it can acquire the obstacle information within the coverage area, and a specific type of the perception unit is not limited in the embodiments of the present disclosure.

In some embodiments, the target UE may acquire its own geographical position information and use it as first position information. After establishing a Radio Resource Control (RRC) connection with a base station, the target UE may report the first position information to the base station, so that the base station can acquire the first position information of the target UE. After acquiring the first position information reported by the target UE, the base station may directly take the first position information of the target UE as the position information of the target UE.

In some embodiments, the target UE may acquire its own geographic position information based on its built-in Global Navigation Satellite System (GNSS) module, or based on a cellular network radio positioning method. If the target UE is an on-board mobile terminal, the target UE may alternatively acquire its own geographic position information through a position area identifier (such as a Zone ID).

In some embodiments, the base station may actively acquire the first position information of the target UE. For example, after the target UE accesses the base station, the base station acquires the geographical position information of the target UE by cellular base station positioning or the like.

In some embodiments, the first position information corresponding to the target UE may reflect a rough position corresponding to the target UE. In some application scenarios, the first position information corresponding to the target UE cannot accurately reflect a precise location of the target UE. For example, if the target UE is blocked by a building, the first position information acquired by GNSS positioning or cellular base station positioning may actually have a large error.

To acquire more accurate position information of the target UE, the base station may acquire the first obstacle information. Afterwards, the base station may combine the first obstacle information and the first position information reported by the target UE to determine an obstacle associated with the target UE. The base station may compare position information corresponding to the obstacle associated with the target UE with the second obstacle information reported by the target UE, thereby determining second position information of the target UE. Compared with the first position information, the second position information can more accurately reflect the position information of the target UE.

In some embodiments, the second position information of the target UE is used as the position information of the target UE.

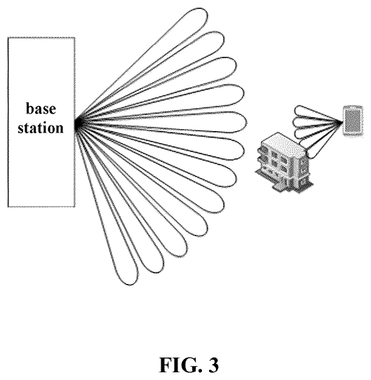

Referring to FIG. 3, an application scenario diagram of a beam scanning method according to an embodiment is provided.

In FIG. 3, the base station transmits beams in different directions within the coverage area to acquire the first obstacle information within the coverage area. There is a target building within the coverage area of the base station, and the target UE is blocked by the target building. At this time, accuracy of the first position information acquired by the target UE through its own GNSS system is relatively low. The target UE reports the first position information to the base station. The base station determines that the target UE is near the target building based on the first position information of the target UE and the first obstacle information.

The base station learns that the target UE has the detection capability and instructs the target UE to perform the detection operation. After receiving an instruction issued by the base station, the target UE reports to the base station the detection range and the second obstacle information which includes target building information.

After receiving the detection range of the target UE and the second obstacle information, the base station compares position information corresponding to the target building with the second obstacle information to determine that the target UE is blocked by the target building.

The target UE being blocked by the target building described in the embodiments means that a beam transmitted by the base station is blocked by the target building, thereby making the target UE unable to directly receive the beam transmitted by the base station.

In the embodiments of the present disclosure, there is no logical sequence between the step of the base station acquiring the first obstacle information within the coverage area and the step of acquiring the position information of the target UE. That is, the base station may simultaneously perform the step of acquiring the first obstacle information within the coverage area and the step of acquiring the position information of the target UE: or first perform the step of acquiring the first obstacle information within the coverage area, and then perform the step of acquiring the position information of the target UE: or first perform the step of acquiring the position information of the target UE, and then perform the step of acquiring the first obstacle information within the coverage area.

In S102, the base station determines an optimal beam corresponding to the target UE based on the obstacle information and the position information of the target UE.

In some embodiments, after acquiring the obstacle information and the position information of the target UE, the base station may determine the optimal beam corresponding to the target UE.

In some embodiments, if there is an obstacle between the base station and the target UE, the beam transmitted by the base station cannot be directly received by the target UE. At this time, the optimal beam determined by the base station may be a beam that can be received by the target UE after reflection.

In some embodiments, if the base station can receive the second obstacle information detected by the target UE, the base station may reconstruct object distribution information within the coverage area based on the first obstacle information, the second obstacle information and the position information of the target UE, and then determine the optimal beam based on the object distribution information.

In some embodiments, the base station may reconstruct a 3D map within the coverage area, and determine the optimal beam based on the 3D map and the position information of the target UE.

From above, in the embodiments of the present disclosure, as the optimal beam is determined based on the obstacle information within the coverage area and the position information of the target UE, the optimal beam can be determined without performing full-angle beam scanning, thereby effectively reducing complexity of the beam scanning process.

Referring to FIG. 2, FIG. 2 is a block diagram of a beam scanning apparatus 20 according to an embodiment. The beam scanning apparatus 20 includes an acquiring circuitry 201 and a determining circuitry 202.

The acquiring circuitry 201 is configured to acquire obstacle information within a coverage area and position information of a target UE.

The determining circuitry 202 is configured to determine an optimal beam corresponding to the target UE based on the obstacle information and the position information of the target UE.

In some embodiments, more details of the acquiring circuitry 201 and the determining circuitry 202 may be referred to the above descriptions of S101 and S102, and are not repeated here.

In some embodiments, modules/units included in each apparatus and product described in the above embodiments may be software modules/units, hardware modules/units, or a combination of software modules/units and hardware modules/units.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a non-volatile or non-transitory computer-readable storage medium having computer instructions stored therein is provided, wherein when the computer instructions are executed by a processor, the beam scanning method provided in any one of the above embodiments is performed.

In an embodiment of the present disclosure, a beam scanning apparatus including a memory and a processor is provided, wherein the memory has computer instructions stored therein, and when the processor executes the computer instructions, the beam scanning method provided in any one of the above embodiments is performed.

Those skilled in the art could understand that all or part of steps in the various methods in the above embodiments can be completed by instructing relevant hardware through a program, and the program can be stored in any computer-readable storage medium which includes a ROM, a RAM, a magnetic disk or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A beam scanning method, comprising:
acquiring obstacle information within a coverage area and position information of a target User Equipment (UE); and
determining an optimal beam corresponding to the target UE based on the obstacle information and the position information of the target UE.

2. The method according to claim 1, wherein said acquiring the obstacle information within the coverage area comprises:
transmitting a detection signal within the coverage area, and determining first obstacle information within the coverage area based on an echo of the detection signal; and
taking the first obstacle information as the obstacle information within the coverage area.

3. The method according to claim 1, wherein said acquiring the obstacle information within the coverage area comprises:
transmitting a detection signal within the coverage area, and determining first obstacle information within the coverage area based on an echo of the detection signal;
acquiring a detection range of the target UE and second obstacle information detected by the target UE within the detection range; and
taking the first obstacle information and the second obstacle information as the obstacle information.

4. The method according to claim 3, wherein prior to said acquiring the detection range of the target UE and the second obstacle information detected by the target UE within the detection range, the method further comprises:
following determining that the target UE has detection capability, instructing the target UE to perform a detection operation to make the target UE report the detection range and the second obstacle information.

5. The method according to claim 3, wherein said acquiring the position information of the target UE comprises:
receiving first position information reported by the target UE;
acquiring the first obstacle information;
determining an obstacle associated with the target UE based on the first position information and the first obstacle information; and
comparing position information corresponding to the obstacle associated with the target UE with the second obstacle information to acquire second position information of the target UE and taking the second position information as the position information of the target UE.

6. The method according to claim 5, wherein said acquiring the obstacle information within the coverage area comprises:
transmitting a detection signal within the coverage area and determining the obstacle information within the coverage area based on an echo of the detection signal.

7. The method according to claim 1, wherein said acquiring the position information of the target UE comprises:
receiving first position information reported by the target UE; and
taking the first position information as the position information of the target UE.

8. (canceled)

9. A non-volatile or non-transitory computer-readable storage medium storing one or more programs, the one or more programs comprising computer instructions, which, when executed by a processor, cause the processor to:
acquire obstacle information within a coverage area and position information of a target User Equipment (UE); and
determine an optimal beam corresponding to the target UE based on the obstacle information and the position information of the target UE.

10. A beam scanning apparatus comprising a memory and a processor, wherein the memory stores one or more programs, the one or more programs comprising computer instructions, which, when executed by the processor, cause the processor to:
acquire obstacle information within a coverage area and position information of a target User Equipment (UE); and
determine an optimal beam corresponding to the target UE based on the obstacle information and the position information of the target UE.

11. The method according to claim 4, wherein said acquiring the position information of the target UE comprises:
receiving first position information reported by the target UE;
acquiring the first obstacle information;
determining an obstacle associated with the target UE based on the first position information and the first obstacle information; and
comparing position information corresponding to the obstacle associated with the target UE with the second obstacle information to acquire second position information of the target UE and taking the second position information as the position information of the target UE.

12. The method according to claim 11, wherein said acquiring the obstacle information within the coverage area comprises:
transmitting a detection signal within the coverage area and determining the obstacle information within the coverage area based on an echo of the detection signal.

13. The apparatus according to claim 10, wherein the processor is further caused to:
transmit a detection signal within the coverage area, and determine first obstacle information within the coverage area based on an echo of the detection signal; and
take the first obstacle information as the obstacle information within the coverage area.

14. The apparatus according to claim 10, wherein the processor is further caused to:
transmit a detection signal within the coverage area, and determine first obstacle information within the coverage area based on an echo of the detection signal;
acquire a detection range of the target UE and second obstacle information detected by the target UE within the detection range; and
take the first obstacle information and the second obstacle information as the obstacle information.

15. The apparatus according to claim 14, wherein the processor is further caused to:
prior to said acquiring the detection range of the target UE and the second obstacle information detected by the target UE within the detection range and following determining that the target UE has detection capability, instruct the target UE to perform a detection operation to make the target UE report the detection range and the second obstacle information.

16. The apparatus according to claim 14, wherein the processor is further caused to:
receive first position information reported by the target UE;
acquire the first obstacle information;
determine an obstacle associated with the target UE based on the first position information and the first obstacle information; and
compare position information corresponding to the obstacle associated with the target UE with the second obstacle information to acquire second position information of the target UE and take the second position information as the position information of the target UE.

17. The apparatus according to claim 16, wherein the processor is further caused to:
transmit a detection signal within the coverage area and determine the obstacle information within the coverage area based on an echo of the detection signal.

18. The apparatus according to claim 10, wherein the processor is further caused to:
receive first position information reported by the target UE; and
take the first position information as the position information of the target UE.

19. The apparatus according to claim 15, wherein the processor is further caused to:
receive first position information reported by the target UE;
acquire the first obstacle information;
determine an obstacle associated with the target UE based on the first position information and the first obstacle information; and
compare position information corresponding to the obstacle associated with the target UE with the second obstacle information to acquire second position information of the target UE and take the second position information as the position information of the target UE.

20. The apparatus according to claim 19, wherein the processor is further caused to:
transmit a detection signal within the coverage area and determine the obstacle information within the coverage area based on an echo of the detection signal.
